(19) United States
(12) Patent Application Publication
(10) Pub. No.: US 2023/0169630 A1
(43) Pub. Date: Jun. 1, 2023

(54) IMAGE COMPENSATION SERVICE

(71) Applicant: FORD GLOBAL TECHNOLOGIES, LLC, Dearborn, MI (US)

(72) Inventors: Ali HASSANI, Ann Arbor, MI (US); Justin MILLER, Berkley, MI (US); Medha KARKARE, Canton, MI (US)

(21) Appl. No.: 17/540,115

(22) Filed: Dec. 1, 2021

(51) Int. Cl. G06T 5/00; G06T 5/50; G06T 7/33; G06N 20/00

(52) U.S. Cl. CPC G06T 5/006; G06T 5/002; G06T 5/50; G06T 7/337; G06N 20/00

(57) ABSTRACT

Normalizing image data for use by one or more services is provided. One or more original images are received from an image sensor. A sensor calibration corresponding to the image sensor is identified. Based on the sensor calibration, one or more image compensations are performed on the one or more original images to generate a corresponding one or more compensated images in a consistent image format. The one or more compensated images are utilized with one or more services.

### TECHNICAL FIELD

Aspects of the disclosure relate to an image compensation service for operation with one or more services configured to operate upon image data.

### BACKGROUND

Vehicle features may involve detection of persons, objects, and their locations in the vehicle. Such features may include driver monitoring systems (DMS), child seat alerts, and passenger monitoring. These features may make use of cameras to detect the persons and objects. The types of cameras and the applications for camera data may differ between vehicles.

### SUMMARY

In one or more illustrative examples, a system for normalizing image data for use by one or more services is provided. One or more hardware processors are programmed to receive one or more original images from an image sensor; identify a sensor calibration corresponding to the image sensor; based on the sensor calibration, perform one or more image compensations on the one or more original images to generate a corresponding one or more compensated images in a consistent image format; and utilize the one or more compensated images with one or more services.

In one or more illustrative examples, a method for normalizing image data for use by one or more services is provided. One or more original images are received from an image sensor. A sensor calibration corresponding to the image sensor is identified. Based on the sensor calibration, one or more image compensations are performed on the one or more original images to generate a corresponding one or more compensated images in a consistent image format. The one or more compensated images are utilized with one or more services.

In one or more illustrative examples, a non-transitory computer-readable medium is provided that includes instructions for normalizing image data for use by one or more services that, when executed by one or more hardware processors, cause the one or more hardware processors to perform operations including to receive one or more original images from an image sensor; identify a sensor calibration corresponding to the image sensor; based on the sensor calibration, perform one or more image compensations on the one or more original images to generate a corresponding one or more compensated images including the data of respective ones of the one or more original images in a common format, the one or more compensated images being generated in a consistent format with respect to perspective, field of view, resolution, and/or spectrum; and utilize the one or more compensated images with one or more services.

### BRIEF DESCRIPTION OF THE DRAWINGS

FIG. 1 illustrates an example block diagram of a system including a camera compensation service for use in normalizing image data for use by one or more services;

FIG. 2 illustrates further aspects of the camera compensation service of FIG. 1;

FIG. 3 illustrates an example common environment in which a calibration for image sensors may be performed;

FIG. 4 illustrates an example robot arm for repeatably positioning the image sensor in the common environment of FIG. 3;

FIG. 5 illustrates an example process for normalizing image data for use by one or more services; and

FIG. 6 illustrates an example of a computing device for use by the camera compensation service.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

A camera compensation service may be provided that centralizes algorithmic image pre-processing to transform camera image inputs into a common format for further processing. The pre-processing may include, as some non-limiting examples, lens distortion correction, image flat-fielding, environment filtering (e.g., temporal noise and ambient subtraction), mapping thermal data with visible camera data, and packaging the data into a common format (such as either a single RGB-IR-Thermal frame (5 channel) or synchronized RGB, IR and Thermal frames). The pre-processing may also include adjusting perspective to align with others, e.g., surround view cropping/distortion correction. In another example, the camera compensation service may be used to preprocess the format of vector fields that infer 3D-space geometry (both outside and within vehicle) into a common format.

In some applications, the further processing may be image recognition using a trained machine learning model. This may allow the artificial intelligence (AI) modeling to be done on the common format, reducing recognition errors, and speeding up model training. Different types of sensors may be calibrated with respect to a common environment. For instance, each sensor may be is mounted and subjected to the same calibration scene. Further aspects of the disclosure are discussed in detail herein.

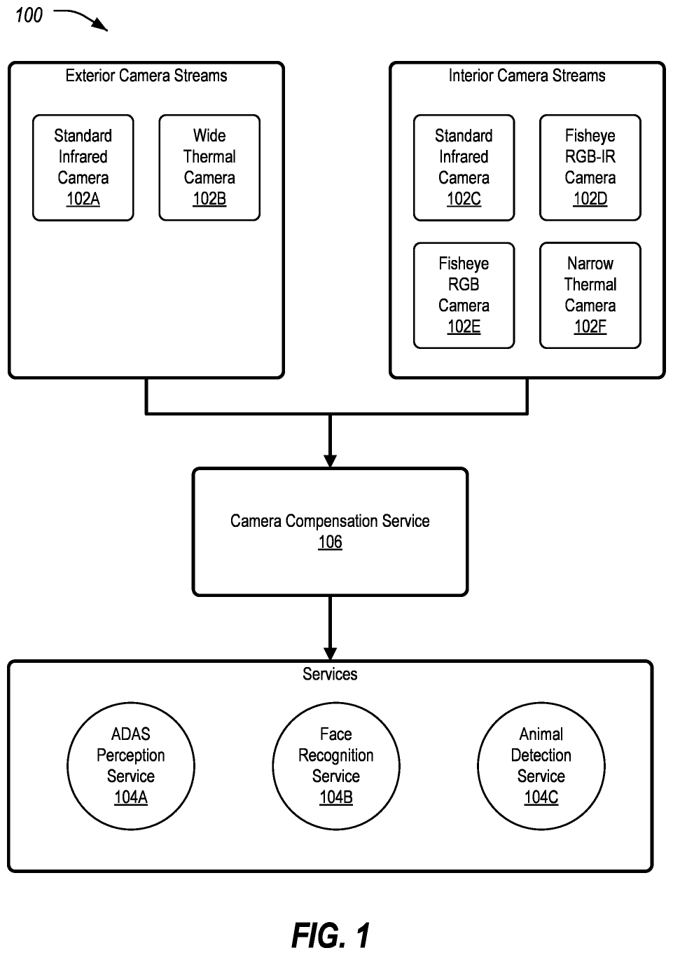

FIG. 1 illustrates an example block diagram of a system 100 including a camera compensation service 106 for use in normalizing image data for use by one or more services 104. As shown, the system includes one or more image sensors 102. The image sensors 102 may include cameras or other imaging sensors configured to generate image data of their surroundings. For instance, image sensors may be placed to capture imaging of the interior of a vehicle and/or to capture imaging exterior to the vehicle. In many examples the image data may be stored as a rectangular array of pixels, where each pixel corresponds to a portion of the image. In some examples, the image data may be a single color or channel (e.g., infrared), forming a single matrix of pixels. In other examples, the image data may be a color image having separate pixel values for multiple color channels, such as red, green, and blue.

As some non-limiting specific examples of the image sensors 102, the system 100 may include one or more of: an infrared camera 102A configured to capture infrared imaging exterior to the vehicle with a standard field of view, a thermal camera 102B configured to capture infrared imaging exterior to the vehicle with a wider field of view than the infrared camera 102A, an infrared camera 102C configured to capture infrared imaging interior to the vehicle with a standard field of view, a fisheye RGB-IR camera 102D configured to capture visible light and infrared imaging interior to the vehicle with a fisheye field of view, a fisheye RGB camera 102E configured to capture visible light but not infrared imaging interior to the vehicle with a fisheye field of view, and a narrow thermal camera 102F configured to capture infrared imaging interior to the vehicle with a narrow field of view.

The system 100 may also include one or more services 104 configured to utilize data from the image sensors 102 to perform various operations. For instance, the one or more services 104 may include a service 104A configured to perform ADAS perception, a service 104B configured to perform face recognition, and a service 104C configured to perform animal detection.

It should be noted that while many examples herein relate to of camera-based image sensors 102, the aspects of a unified method of pre-processing data from image sensors 102 broadly applies to vision processing. For example, the image sensors 102 may additionally or alternately include radars, ultrasonic sensors, lidar sensors, or other types of sensors that for which a common format of sensor data may be useful to downstream services 104.

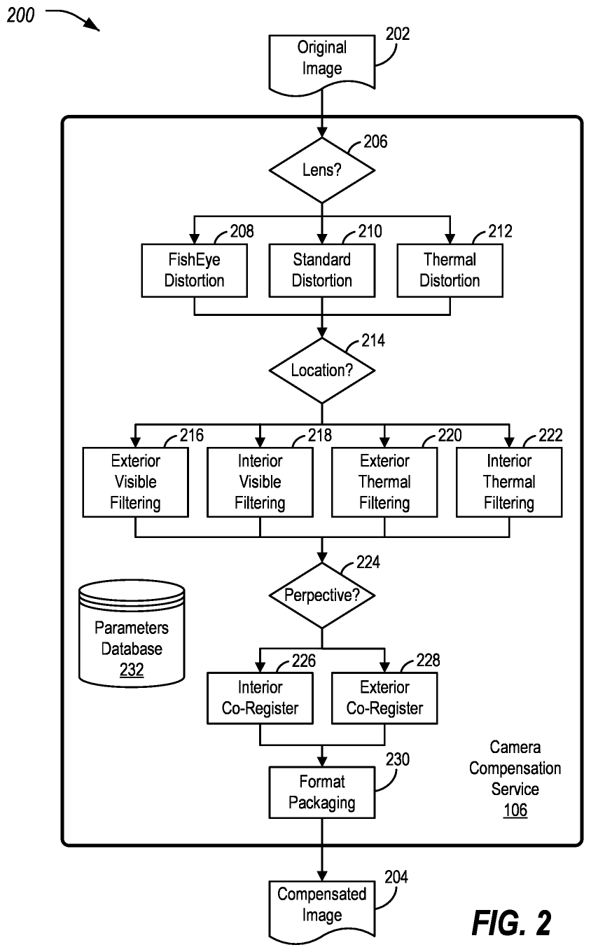

As shown in FIG. 2, and with continued reference to FIG. 1, the camera compensation service 106 may be configured to receive an original image 202 from one of the image sensors 102 and convert that image into a compensated image 204. The original image 202 may be received in various formats based on the configuration of the one of the image sensors 102 capturing the image 202. For instance, the perspective, field of view, resolution, and spectrum of the original image 202 may vary. The compensated image 204, however, may be provided in a consistent format with respect to perspective, field of view, resolution, and/or spectrum.

The camera compensation service 106 may be configured to perform one or more operations on the original image 202 to convert the original image 202 into the compensated image 204. The resultant format after the processing may be a common representation that is usable across applications. Example operations to perform the compensation are shown in the example process 200 of FIG. 2. Generally, the camera compensation service 106 may centralize compensation methods as well as apply transformations to normalizing the format of the original image 202 into the compensated image 204 common format. The compensation methods may include lens distortion correction, image flat-fielding, and environment filtering (e.g., temporal noise and ambient subtraction). The camera compensation service 106 may also perform transformations such as co-registering (e.g. mapping thermal data with visible camera data) as well as packaging of the image into a common format. The camera compensation service 106 may also perform perspective alignment in some examples. The camera compensation service 106 may also perform commonizing of vector fields. It should be noted that the illustrated operations are examples, and more, fewer, different, or differently ordered operations to convert the original image 202 into the compensated image 204 may be utilized.

As shown at operation 206, the camera compensation service 106 determines lens aspects of the original image 202. The lens aspects may be used to determine the field of view or other image mapping of the original image 202. For instance, some images 202 may be taken with an image sensor 102 using a rectilinear lens producing straight lines of perspective, while other images 202 may be taken with an image sensor 102 using a wide-angle lens producing a convex non-rectilinear image. Or, some images 202 may evidence thermal distortion waves that occurs when rising heat waves cause changes in refractive index or otherwise distort the path of light to the image sensor 102.

In an example, the camera compensation service 106 may read metadata information of the original image 202 specifying aspects of the lens and/or field of view of the original image 202. In another example, the camera compensation service 106 may additionally or alternately perform image detection approaches on the original image 202 to identify artifacts in the image such as perspective lines indicative of a fisheye lens and/or waves indicative of thermal distortion.

At operation 208, the camera compensation service 106 corrects detected fisheye distortion to convert the image into a rectilinear image. This may be done, for example, using a barrel distortion correction approach where pixel distances from an optical center are mapped according to a polynomial function.

At operation 210, the camera compensation service 106 corrects standard distortions for the image sensor 102. In an example, the camera compensation service 106 may correct for predefined aspects of the image sensor 102 that produced the original image 202. For instance, these corrections may be performed based on a calibration of the image sensor 102 (discussed in further detail below). The calibrations applied to the original image 202 to produce the compensated image 204 may include a configuration specific to the image sensor 102 that is used as the source for the original image 202. For instance, the configuration for the image sensor 102 may specify information such as how much lens distortion correction, image flat-fielding, and environment filtering to be applied to original images 202 from the image sensor 102. These calibrations may be stored to and retrieved from a parameters database 232.

At operation 212, the camera compensation service 106 corrects thermal distortion. In an example, the camera compensation service 106 may identify a distortion displacement mapping for the image based on automated line tracing of the original image 202 and/or using thermal information embedded in the original image 202. This displacement mapping may then be used to transform the image to straighten out the thermal distortion waves.

In addition, as shown at operation 214, the camera compensation service 106 may determine location aspects of the original image 202 to use for image cleanup operations. This may include, for example, environment filtering such as temporal noise reduction and ambient noise subtraction. As shown, based on whether the original image 202 is from an exterior or interior location, and/or based on whether the image is a thermal image or a visible spectrum image, different filtering may be performed. The internal and or thermal aspects of the image 202 may be determined based on image metadata, and/or based on image recognition techniques as noted above for lens aspects. As shown at operation 216 exterior visible filtering is performed, at operation 218 interior visible filtering is performed, at operation 220 exterior thermal filtering is performed, and at operation 222 interior thermal filtering is performed.

In addition, as shown at operation 224, the camera compensation service 106 may determine perspective aspects of the original image 202 to use for image mapping to a common viewpoint. For instance, an image sensor 102 may be located at position T₁ (X, Y, Z) while the common viewpoint position may be position T₂ (X, Y, Z). The data of the original image 202 may then be projected from the position T₁ to the position T₂ using a homogenous transformation. The transformation matrix may be pre-computed according to T₁ and T₂, for example. In some examples these operations may take into account secondary camera metrics (e.g., focal length, aspect ratio, etc.) to properly map pixels into the common format.

In another aspect, as shown at operation 226 for internal image sensors 102 and as shown at operation 228 for external image sensors 102, co-registering may be performed to the original image 202 using images from other image sensors 102 covering overlapping areas of the original image 202. In an example, thermal data may be mapped with visible image data into a single image.

As shown at operation 230, the original image 202 as processed by the process 200 may be packaged into a common format. As some examples, this common format may include a single RGB-IR-Thermal frame (e.g., 5 channel) or synchronized RGB, IR and Thermal frames. The result of these operations may be the compensated image 204.

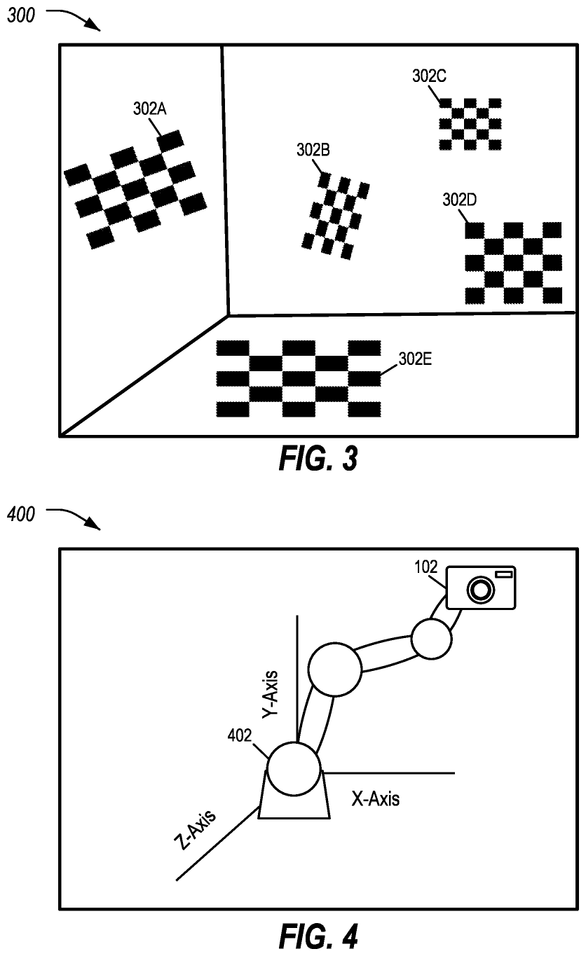

Referring more specifically to the parameters database 232, calibrations may be performed with respect to the different image sensors 102. FIG. 3 illustrates an example common environment 300 in which the calibrations for image sensors 102 may be performed. One approach to providing the configuration specific to the image sensor 102 to calibrate the image sensor 102 with respect to a common environment 300. In this case, the image sensor 102 may be mounted and subjected to a standard calibration scene. To standardize spatial locations, calibration markers 302 may be placed throughout the scene (e.g., checkerboards are shown as the calibration markers 302 but other examples are possible). Then, image data may be retrieved from the image sensor 102 through a repeatable motion. This calibration process may also incorporate 3D geometry in the targets for vector field mapping, i.e., having targets spaced out on the z-axis.

As shown in FIG. 4, an example robot arm 402 may be used to repeatably position the image sensor 102 in the common environment 300. The robot arm 402 may provide for movement in Z, Y and Z axes. For instance, a program may be used to control the robot arm 402 into one or more predefined locations and also to command the image sensor 102 to take images for analysis at the one or more predefined locations. Although not shown, other factors that may affect image quality, such as ambient lighting, may be reproduced for calibration across each image sensor 102. It should be noted that the targets may also be projected using light sources. For instance, rather than a physical robotic arm, a projector (of the appropriate wavelength) may be utilized to vary the targets to be captured.

Based on the collected calibration data, corresponding frames from different image sensors 102 may be analyzed. This analysis may identify of standard features in the images, which may be used to determine variations in field of view, imaging technology, etc. To confirm the calibration for the image sensor 102, locations of the standard features may be compared to the correct image locations for a properly calibrated image. In an example, the images for the image sensor 102 to be calibrated may be converted into a standardized format by mapping each image into a common color space (e.g., grayscale), where the mapped images are then be compared by measuring pixel-level differences across images to ensure accuracy of the calibration.

Referring back to FIG. 1, the services 104 may utilize the compensated image 204 for processing, not the original image 202. This may accordingly allow for simplification of the services 104 across image sensors 102. As the camera compensation service 106 handles basic image corrections, as well as transformations to incorporate shared information (e.g., thermal and color perspectives of a face) in a common format, the complexity of sensor compensation approaches is removed from the services 104.

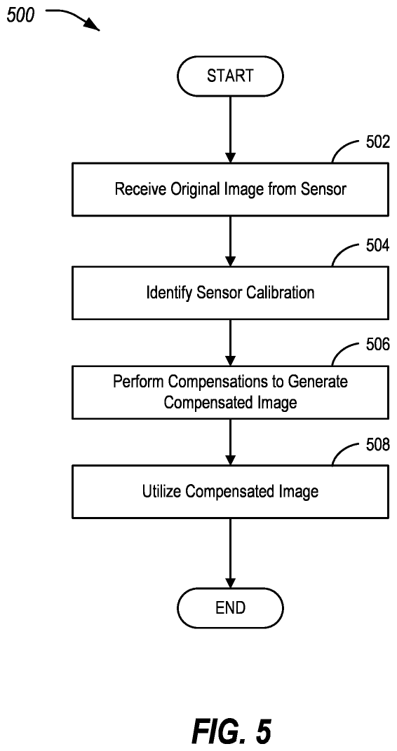

FIG. 5 illustrates an example process 500 for normalizing image data for use by one or more services 104. In an example, the process 500 may be used by the camera compensation service 106 for the training and/or operation of the one or more services 104.

At operation 502, the camera compensation service 106 receives an original image 202 from an image sensor 102. In an example, the camera compensation service 106 receives the original image 202 from one or more of the image sensors 102 of a vehicle. It should be noted, however, that this is but one possible environment, and other locations for image sensors 102 may be utilized, such as a fixed installation in or around a building.

At operation 504, the camera compensation service 106 identifies a sensor calibration for the image sensor from the parameters database 232. In an example, the camera compensation service 106 may retrieve the calibration corresponding to an identifier of the image sensor 102 embedded as metadata in the original image 202 or as otherwise received from the image sensor 102. In another example, the calibration may be predefined, hardcoded, and/or stored to the camera compensation service 106. For instance, the calibrations for the image sensor 102 may specify information such as how much lens distortion correction, image flat-fielding, and environment filtering to be applied to original images 202 from the image sensor 102.

At operation 506, the camera compensation service 106 performs compensations to generate the compensated image 204 from the original image 202. In an example, the camera compensation service 106 may perform one or more of the operations discussed in detail with respect to FIG. 2. These compensations may be tuned based on the calibration corresponding to the identifier of the image sensor 102.

At operation 508, the camera compensation service 106 provides the compensated image 204 for use. In an example, the camera compensation service 106 may provide the compensated image 204 to one or more of the service 104A configured to perform ADAS perception, the service 104B configured to perform face recognition, and the service 104C configured to perform animal detection. After operation 508, the process 500 ends.

By using the process 500, the services 104 may be able to operate without specific processing configured to address differences in the image data provided by the image sensor 102 capturing the original image 202. This accordingly allows for the complexity in handling of different image formats and tips to be avoided in the design of the services 104, improving the reliability and reducing the complexity of the services 104.

For instance, a machine learning model of one or more of the services 104 may be trained on data using the common image format of the compensated image 204. This may allow for machine learning model to be operate abstracted away from various details of image formats and locations of the image sensors 102. There may also be patentable aspects of using the centralized image service to adapt the same set of sensor inputs to the requirements of different recognition services.

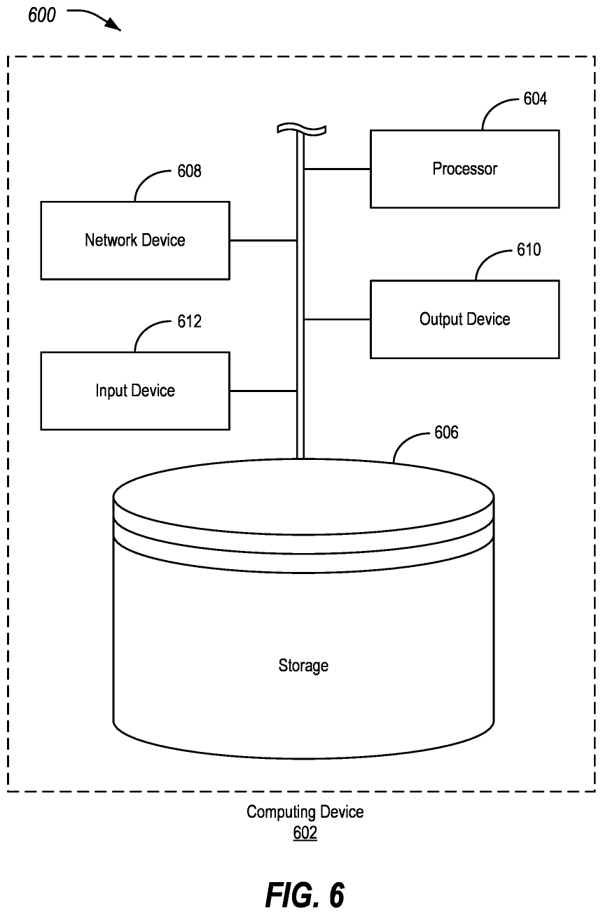

FIG. 6 illustrates an example 600 of a computing device 602 for use implementing the sensor fusion to build active areas of interest for faster processing of deep learning models. Referring to FIG. 6, and with reference to FIGS. 1-5, the hardware performing the operations of the camera compensation service 106 may be an example of such a computing device 602. As shown, the computing device 602 may include a processor 604 that is operatively connected to a storage 606, a network device 608, an output device 610, and an input device 612. It should be noted that this is merely an example, and computing devices 602 with more, fewer, or different components may be used.

The processor 604 may include one or more integrated circuits that implement the functionality of a central processing unit (CPU) and/or graphics processing unit (GPU). In some examples, the processors 604 are a system on a chip (SoC) that integrates the functionality of the CPU and GPU. The SoC may optionally include other components such as, for example, the storage 606 and the network device 608 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 604 executes stored program instructions that are retrieved from the storage 606. The stored program instructions, accordingly, include software that controls the operation of the processors 604 to perform the operations described herein. The storage 606 may include both non-volatile memory and volatile memory devices. The non-volatile memory includes solid-state memories, such as negative-AND (NAND) flash memory, magnetic and optical storage media, or any other suitable data storage device that retains data when the system 100 is deactivated or loses electrical power. The volatile memory includes static and dynamic random-access memory (RAM) that stores program instructions and data during operation of the system 100.

The GPU may include hardware and software for display of at least 2D and optionally 3D graphics to the output device 610. The output device 610 may include a graphical or visual display device, such as an electronic display screen, projector, printer, or any other suitable device that reproduces a graphical display. As another example, the output device 610 may include an audio device, such as a loudspeaker or headphone. As yet a further example, the output device 610 may include a tactile device, such as a mechanically raiseable device that may, in an example, be configured to display braille or another physical output that may be touched to provide information to a user.

The input device 612 may include any of various devices that enable the computing device 602 to receive control input from users. Examples of suitable input devices that receive human interface inputs may include keyboards, mice, trackballs, touchscreens, voice input devices, graphics tablets, and the like.

The network devices 608 may each include any of various devices that enable computing device 602 to send and/or receive data from external devices over networks. Examples of suitable network devices 608 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for normalizing image data for use by one or more services, comprising:
one or more hardware processors programmed to:
receive one or more original images from an image sensor;
identify a sensor calibration corresponding to the image sensor;
based on the sensor calibration, perform one or more image compensations to the one or more original images to generate a corresponding one or more compensated images in a consistent image format; and
utilize the one or more compensated images as input to one or more services.

2. The system of claim 1, wherein the one or more compensated images are generated in the consistent image format with respect to perspective, field of view, resolution, and/or spectrum.

3. The system of claim 1, wherein the one or more hardware processors are further programmed to retrieve the sensor calibration from a parameters database according to an identifier of the image sensor received with the one or more original images.

4. The system of claim 1, wherein the one or more hardware processors are further programmed to:
utilize the one or more compensated images as training data for a machine learning model utilized by the one or more services; and
utilize another compensated image from a second image sensor during operation of the machine learning model, the image sensor and the second image sensor providing original images in different image formats, the compensated images thereby abstracting away aspects of the different image formats.

5. The system of claim 1, wherein the one or more image compensations include to:
correct detected fisheye distortion to convert the one or more original images into a rectilinear image;
correct thermal distortion in the one or more original images; or
filter the one or more original images to remove temporal and/or ambient noise.

6. The system of claim 1, wherein the one or more image compensations include to co-register the one or more original images with additional image data from at least a second image sensor capturing image data of an area overlapping the area of original image capture data.

7. The system of claim 6, wherein to co-register includes to map visible light imaging and infrared imaging together into a common image format.

8. The system of claim 1, wherein the one or more image compensations include a common image bit depth and a common image resolution.

9. A method for normalizing image data for use by one or more services, comprising:
receiving one or more original images from an image sensor;
identifying a sensor calibration corresponding to the image sensor;
based on the sensor calibration, performing one or more image compensations to the one or more original images to generate a corresponding one or more compensated images in a consistent image format; and
utilizing the one or more compensated images as input to one or more services.

10. The method of claim 9, wherein the one or more compensated images are generated in the consistent image format with respect to perspective, field of view, resolution, and/or spectrum.

11. The method of claim 9, further comprising retrieving the sensor calibration from a parameters database according to an identifier of the image sensor received with the one or more original images.

12. The method of claim 9, further comprising:
utilizing the one or more compensated images as training data for a machine learning model utilized by with one or more services; and
utilizing another compensated image from a second image sensor during operation of the machine learning model, the image sensor and the second image sensor providing original images in different image formats, the compensated images thereby abstracting away aspects of the different image formats.

13. The method of claim 9, wherein the one or more image compensations include:
correcting detected fisheye distortion to convert the one or more original images into a rectilinear image;
correcting thermal distortion in the one or more original images; or
filtering the one or more original images to remove temporal and/or ambient noise.

14. The method of claim 9, wherein the one or more image compensations include co-registering the one or more original images with additional image data from at least a second image sensor capturing image data of an area overlapping the area of original image capture data.

15. The method of claim 14, wherein the co-registering including mapping visible light imaging and infrared imaging together into a common image format.

16. The method of claim 9, wherein the one or more image compensations include a common image bit depth and a common image resolution.

17. A non-transitory computer-readable medium comprising instructions for normalizing image data for use by one or more services that, when executed by one or more hardware processors, cause the one or more hardware processors to perform operations including to:
receive one or more original images from an image sensor;
identify a sensor calibration corresponding to the image sensor by retrieving the sensor calibration from a parameters database according to an identifier of the image sensor received with the one or more original images;
based on the sensor calibration, perform one or more image compensations on the one or more original images to generate a corresponding one or more compensated images including the data of respective ones of the one or more original images in a common format, the one or more compensated images being generated in a consistent image format with respect to perspective, field of view, resolution, and/or spectrum; and
utilize the one or more compensated images with one or more services.

18. The medium of claim 17, further comprising instructions that, when executed by the one or more hardware processors, cause the one or more hardware processors to perform operations including to:
utilize the one or more compensated images as training data for a machine learning model utilized by the one or more services; and
utilize another compensated image from a second image sensor during operation of the machine learning model, the image sensor and the second image sensor providing original images in different image formats, the compensated images thereby abstracting away aspects of the different image formats.

19. The medium of claim 17, wherein the one or more image compensations include to:
correct detected fisheye distortion to convert the one or more original images into a rectilinear image;
correct thermal distortion in the one or more original images; or
filter the one or more original images to remove temporal and/or ambient noise.

20. The medium of claim 17, wherein the one or more image compensations include to co-register the one or more original images with additional image data from at least a second image sensor capturing image data of an area overlapping the area of original image capture data, wherein to co-register includes to map visible light imaging and infrared imaging together into a common image format.

21. The medium of claim 17, wherein the one or more image compensations include a common image bit depth and a common image resolution.
